(19) United States
(12) Patent Application Publication
(10) Pub. No.: US 2026/0121322 A1
(43) Pub. Date: Apr. 30, 2026

(54) Bent-type Electrical Connector Assembly and Electrical Connector

(71) Applicants: Tyco Electronics (Shanghai) Co., Ltd., Shanghai (CN); Tyco Electronics Technology (SIP) Co., Ltd., Suzhou (CN)

(72) Inventors: Rongyan Lu, Suzhou (CN); Shiwen (Matt) Chen, Shanghai (CN); Chengjun Zou, Suzhou (CN); Pucha (Richard) Feng, Suzhou (CN); Leilei (Haley) Xu, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/366,757

(22) Filed: Oct. 23, 2025

(30) Foreign Application Priority Data
Oct. 24, 2024 (CN) 202411491890.0

(51) Int. Cl. H01R 12/72; H01R 13/05; H01R 13/424; H01R 13/502; H01R 13/52

(52) U.S. Cl. CPC H01R 12/722; H01R 13/052; H01R 13/424; H01R 13/502; H01R 13/521

(57) ABSTRACT

A bent-type electrical connector assembly includes a dielectric housing and a conductive terminal body. The dielectric housing includes a hollow first segment extending in a longitudinal direction, and a hollow second segment extending in a vertical direction. The second segment is coupled to and internally communicates with the first segment. The terminal body includes a straight pin segment inserted into the first segment in the longitudinal direction, and a straight termination segment angularly coupled to the pin segment and inserted into the second segment in the vertical direction. The second segment is continuously exposed in the vertical direction on a first side parallel to a plane defined by both the longitudinal direction and the vertical direction. When the pin segment is inserted within the first segment, the termination segment is received and retained within the second segment such that the termination segment is pivotable relative to the pin segment.

### CROSS-REFERENCE TO RELATED APPLICATIONS

This application claims the benefit of the filing date under 35 U.S.C. § 119(a)-(d) of Chinese Patent Application No. 202411491890.0, filed on Oct. 24, 2024.

### FIELD OF THE INVENTION

Embodiments of the present disclosure relate to an electrical connector assembly and electrical connector and, more particularly, to a bent-type electrical connector assembly and electrical connector.

### BACKGROUND OF THE INVENTION

An electrical connector assembly is an electronic component for transmission and exchange of electric current or signals between or among electronic system apparatuses. Functioning as a node, independently or together with cables, the electrical connector assembly transmits electric current or signals between or among devices, assemblies, apparatus, and systems, and maintains that no change (such as signal distortion, energy loss) may occur between various systems, thus the electrical connector assembly is a fundamental element necessary for constituting the connections of an entire complete system. For example, I/O modules are typically used for connections between switches, and between a switch and a server.

In the field of data communications, electrical connectors are typically employed to achieve signal transmission between two printed circuit boards (PCBs); specifically, as a typical example, each electrical connector contains respective electrical connector assemblies, and the two mutually mating electrical connector assemblies of the paired electrical connectors are installed on the two printed circuit boards respectively, and then these two electrical connector assemblies are mated together to achieve signal transmission between the two printed circuit boards. Existing electrical connector assemblies typically include an insulating housing (such as a plastic housing) and contact conductive terminals (including signal terminals and ground terminals) assembled in the insulating housing. By assembling the contact conductive terminals of each of the paired electrical connector assemblies in the paired electrical connectors, physical interconnection and electrical connection between the two circuit boards are achieved.

The main structure of typical electrical connector assemblies is usually an electrical connector assembly structure with a 180-degree straight cable outlet, i.e., a 180-degree electrical connector assembly. Considering that when paired electrical connector assemblies are connected to each other, the straight structure of the electrical connector assembly sometimes cannot meet wiring requirements, making the cables of the electrical connector assembly inconvenient for routing and prone to interference with other components, affecting the performance and lifespan of the connector. Therefore, based on the original 180-degree straight cable outlet, a product structure with a bent, for example, 90-degree tail outlet is added, thereby giving rise in the field to bent-type electrical connector assemblies where the main structure of the electrical connector assembly is a right-angle structure.

In a bent-type electrical connector assembly, i.e., a right-angle connector, the straight mating end for extending the terminals for plug-in mating with a matching electrical connector assembly's receptacle, and the vertical termination end for the bent, for example, 90-degree tail outlet, are substantially perpendicular to each other. The design, manufacture, and assembly of such electrical connectors are complex and expensive. As the signal path turns, for example, 90 degrees within the dielectric housing of the electrical connector assembly (thus forming a right-angle corner at the transition between the mating end and the termination end), it is difficult to maintain the impedance of such connectors between the mating end and the termination end. Furthermore, typical right-angle connectors do not allow automated manufacturing. For example, in some existing right-angle connectors, the central terminal body for conductive contact (e.g., in the form of a pin) is inserted into the dielectric housing of the electrical connector assembly and is then manually bent, for example, 90 degrees, using a tool, to form the signal transmission path through the right-angle corner of the bent-type electrical connector assembly. Additionally, it is often difficult to form the dielectric housing such that the bent right-angle corner completely surrounds the terminal body, which may reduce shielding and potentially attenuate electrical signals.

Bent-type electrical connector assemblies are typically manufactured using two structures: a press-fit assembly structure where the terminal body is pressed into the dielectric housing, and an integral molding structure where the terminal body and the dielectric are integrally injection molded. However, both structures of related art bent-type electrical connector assemblies, formed in different ways, inherently possess technical defects.

On one hand, in the press-fit assembly structure for bent-type electrical connector assemblies, implementing the assembly between the terminal body and the dielectric housing (serving as an insulator support) requires forming barb structures axially on the terminal body to achieve a stop structure that resists reverse withdrawal movement of the terminal body without hindering insertion and suppressing axial forward and backward movement of the terminal body within the dielectric housing. However, since the barb-forming location is on the straight mating end adjacent to the right-angle corner, i.e., slightly axially rearward on the straight mating end and close to the vertical termination end, the axial force point during the near-right-angle bending insertion process is difficult to control; and because the force point at the near-right-angle bend of the terminal body at the right-angle corner cannot be accurately determined, the insertion depth of the terminal body also requires specific process control. Moreover, axial force applied to the terminal body easily causes deformation. Further, since the originally straight pin-shaped terminal body is bent at a near-right angle at the right-angle corner, bending easily induces springback, prestress, and even local prestrain. Consequently, axial force on the terminal body easily leads to deformation, and the springback of the terminal body after bending affects positional accuracy. Furthermore, such barb structures affect the impedance of the terminal body compared to a smooth terminal body.

On the other hand, the integral molding structure for bent-type electrical connector assemblies requires specially designed molds, leading to high mold investment. Furthermore, because the terminal body requires pre-formed connected terminal strips at the top (which are removed, for example by cutting or breaking, after the overall formation of the electrical connector assembly), significant limitations arise, resulting in many irregular sub-structures in the product and restricted high-frequency performance of the overall electrical connector assembly.

Furthermore, conventional bent-type electrical connector assemblies include multiple separate components, making automated assembly difficult; and due to complexity, the number of different components, and manufacturing processes, typical bent-type electrical connector assemblies are typically assembled manually, which is time-consuming. Therefore, there is a need for bent-type electrical connector assemblies and their components that provide effective signal path shielding, reduce the number of components, and allow automated manufacturing and assembly.

Thus, there is an urgent need for an improved bent-type electrical connector assembly and its components, which are achieved, for example, through improvements in the assembly structure, thereby, on one hand, eliminating the inherent barbs and uncertain bending corners in press-fit assembly structures and overcoming the resulting adverse effects in terms of force/structure and impedance matching, while still ensuring avoidance of reverse withdrawal movement and axial movement of the terminal body relative to the insertion direction; on the other hand, eliminating the inherent strips in integral molding structures, improving their high-frequency performance. Consequently, the anticipated bent-type electrical connector assembly and its components facilitate simple assembly of a pre-processed, nearly right-angled bent terminal body relative to a pre-formed dielectric housing, achieving reliable relative fixation and positioning between the nearly right-angled bent terminal body and the pre-formed dielectric housing, enhancing the structural strength of the components of the electrical connector assembly, reducing deformation and accumulated stress generated during the insertion process, and improving assembly accuracy as well as impedance matching and high-frequency performance.

### SUMMARY OF THE INVENTION

A bent-type electrical connector assembly includes a dielectric housing and a conductive terminal body. The dielectric housing includes a hollow first segment extending in a longitudinal direction, and a hollow second segment extending in a vertical direction. The second segment is coupled to and internally communicates with the first segment. The terminal body includes a straight pin segment inserted into the first segment in the longitudinal direction, and a straight termination segment angularly coupled to the pin segment and inserted into the second segment in the vertical direction. The second segment is continuously exposed in the vertical direction on a first side parallel to a plane defined by both the longitudinal direction and the vertical direction. When the pin segment is inserted within the first segment, the termination segment is received and retained within the second segment such that the termination segment is pivotable relative to the pin segment.

### BRIEF DESCRIPTION OF DRAWINGS

The invention will now be described by way of example with reference to the accompanying figures, of which:

FIG. 1A is a perspective view of an electrical connector assembly according to an embodiment;

FIG. 1B is an exploded view of the electrical connector assembly of FIG. 1A;

FIG. 2A is a perspective view of a dielectric housing of the electrical connector assembly of FIG. 1A;

FIG. 2B is an enlarged view of a portion indicated by an oval dashed frame in FIG. 2A;

FIG. 3A is a front view of the dielectric housing of FIG. 2A;

FIG. 3B is a rear view of the dielectric housing of FIG. 2A;

FIG. 3C is a left-side view of the dielectric housing of FIG. 2A;

FIG. 3D is a right-side view of the dielectric housing of FIG. 2A;

FIG. 3E is a top view of the dielectric housing of FIG. 2A;

FIG. 3F is a bottom view of the dielectric housing of FIG. 2A;

FIG. 3G is a longitudinal cross-sectional view of the dielectric housing of FIG. 2A;

FIG. 4A is an enlarged view of a portion indicated by the circular dashed frame in FIG. 3A;

FIG. 4B is an enlarged view of the portion indicated by the circular dashed frame in FIG. 3A according to an another embodiment;

FIG. 4C is an enlarged view of the portion indicated by the circular dashed frame in FIG. 3A according to yet another embodiment;

FIG. 4D is an enlarged view of the portion indicated by the circular dashed frame in FIG. 3A according to yet an another embodiment;

FIG. 5 is a longitudinal cross-sectional view of an assembled state of a terminal body of the electrical connector assembly of FIG. 1A and the dielectric housing of FIG. 2A;

FIG. 6A is a perspective view of an electrical connector in an assembled state according to an embodiment; and

FIG. 6B is an exploded view of the electrical connector of FIG. 6A.

### DETAILED DESCRIPTION

The present disclosure will now be described in detail with reference to the drawings, which are provided as illustrative examples of the present disclosure to enable those skilled in the art to practice the disclosure. It is to be noted that the following drawings and examples are not intended to limit the scope of the disclosure to a single embodiment, but other embodiments are possible by interchanging some or all of the described or illustrated elements. Moreover, where known components may be used partially or entirely to implement elements of the present disclosure, only those parts of such known components necessary for understanding the present disclosure will be described, and detailed descriptions of other parts of such known components will be omitted so as not to obscure the present disclosure. Unless otherwise specified herein, as will be understood by those skilled in the art, embodiments described as implemented in software should not be limited as such, but may include embodiments implemented in hardware or a combination of software and hardware, and vice versa. In this specification, embodiments showing singular components should not be considered to be limiting; rather, unless explicitly stated otherwise herein, the present disclosure is intended to encompass other embodiments including a plurality of the same components, and vice versa.

Furthermore, the applicant does not intend that any terms in the specification or claims be ascribed an uncommon or special meaning unless explicitly stated as such. Additionally, the present disclosure encompasses present and future known equivalents of the known components referred to herein by way of illustration.

Unless otherwise specified, “bottom” and “top”, “upper” and “lower”, etc., appearing in the content recorded in the present disclosure are relative concepts. And “corresponding” or “respective” appearing in the content recorded in the present disclosure refers to the correspondence between components that are used in pairs and work cooperatively.

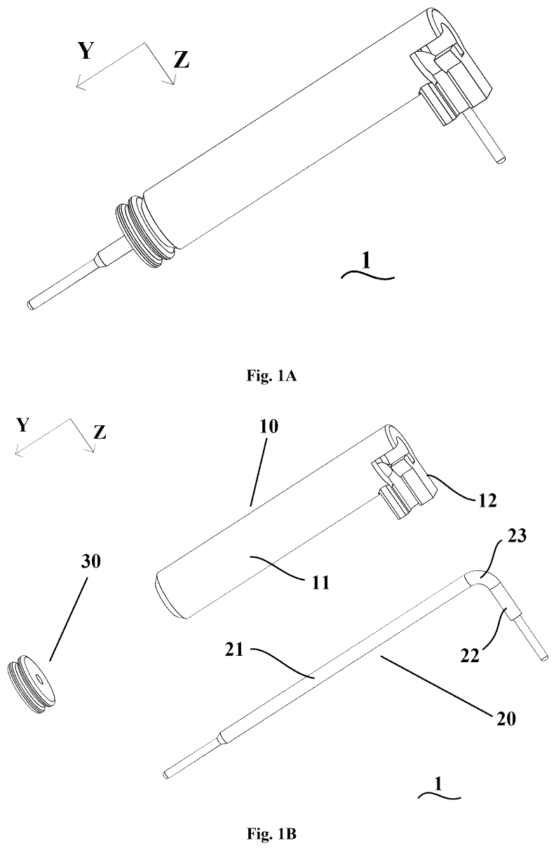

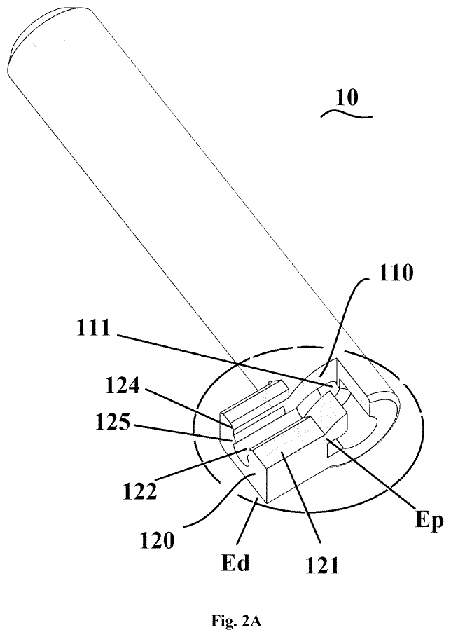

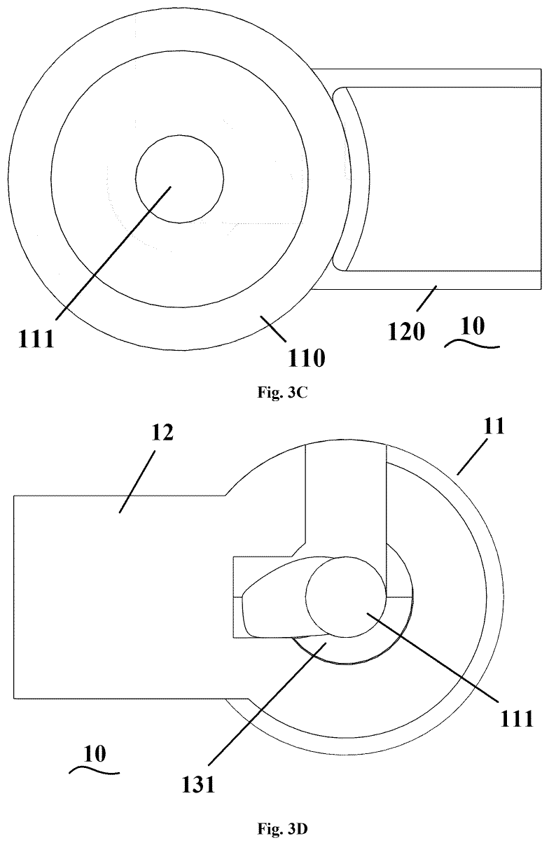

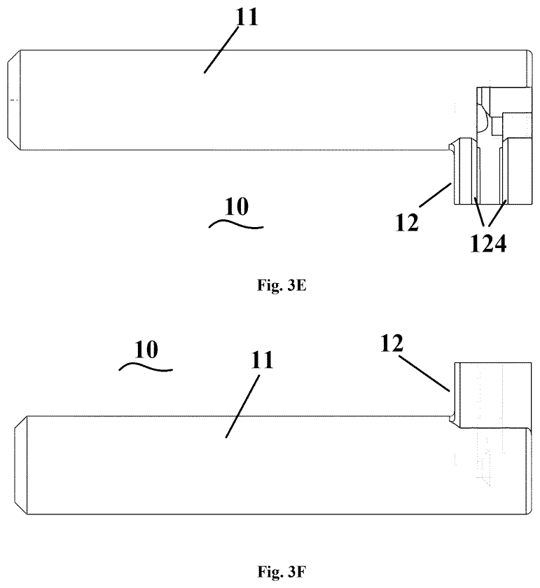

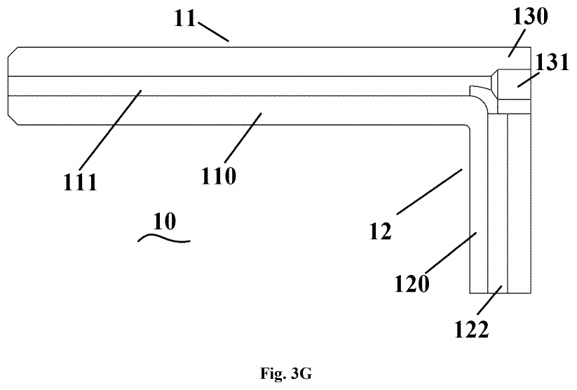

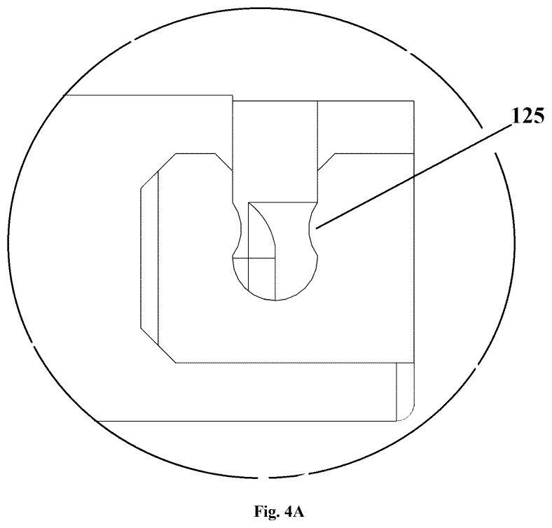

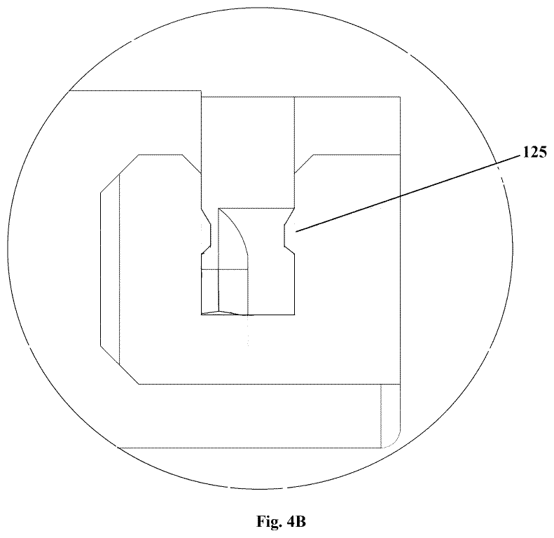

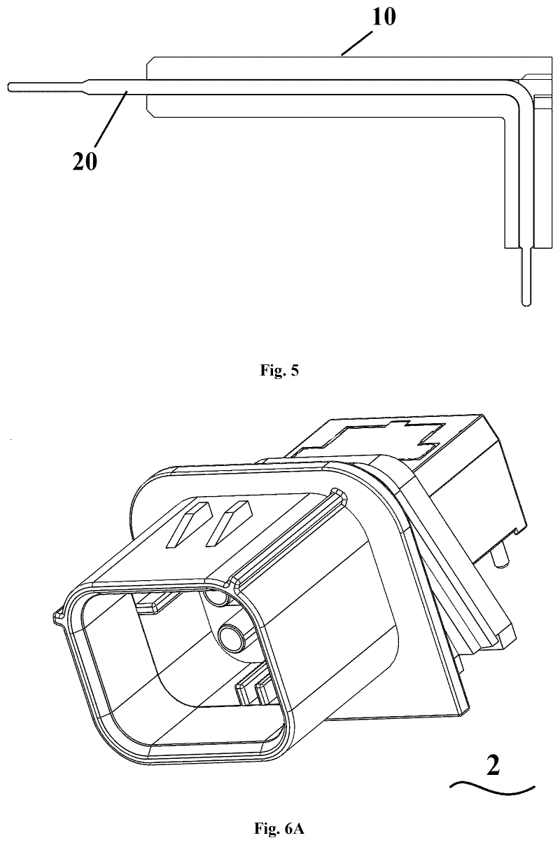

An exemplary embodiment of a bent-type electrical connector assembly 1 will now be described with reference to FIGS. 1A-5. As shown in FIGS. 1A and 5, the bent-type electrical connector assembly 1 includes a dielectric housing 10 and a conductive terminal body 20. As shown in FIGS. 1B and FIGS. 3D-3G, the dielectric housing 10 includes a hollow first segment 11 extending in a longitudinal direction Y, and a hollow second segment 12 extending in a vertical direction Z angled (e.g., orthogonal) relative to the longitudinal direction Y. The second segment 12 is coupled to the first segment 11 and internally communicates with the first segment 11. The terminal body 20 includes a straight pin segment 21, as shown in FIG. 1B, adapted to be inserted into the first segment 11 in the longitudinal direction Y, and a straight termination segment 22, as shown in FIG. 1B, angularly coupled to the pin segment 21 (e.g., orthogonally) and adapted to be inserted into the second segment 12 in the vertical direction Z. The second segment 12 is continuously exposed in the vertical direction Z on a first side 121 parallel to a plane defined collectively by both the longitudinal direction Y and the vertical direction Z, and the terminal body 20 is arranged such that, with the pin segment 21 being inserted in place within the first segment 11, the termination segment 22 is received in the second segment 12 in a manner that is pivotable relative to the pin segment 21.

The electrical connector assembly 1, for example, includes the dielectric housing 10 made of an insulating material such as plastic, and the terminal body 20 made of a conductive material such as metal. More specifically, in some applications, for example, the dielectric housing 10 is made of a plastic part such as an LCP material. Such a dielectric housing 10 can be simply pre-formed by existing processes such as molding, thereby simplifying manufacturing. As an example, the terminal body 20 is then installed within the dielectric housing 10. In some embodiments, for example, as shown in the figures, the terminal body 20 includes, for example, a conductive terminal core and a terminal sheath wrapped around the surface of the terminal core. At both ends of the terminal body 20, the terminal core is exposed from the terminal sheath for use in plug-in electrical connection with a mating electrical connection and for termination with a cable.

As shown in FIG. 1B, for example, the terminal body 20 further includes a curved transition segment 23. The pin segment 21 and the termination segment 22 are coupled to each other via the transition segment 23, and the transition segment 23 is adapted to be accommodated within a communication cavity defined internally at a junction between the first segment 11 and the second segment 12. Thus, various parts of the terminal body 20 are adapted to be accommodated in corresponding internal parts of the hollow dielectric housing 10, respectively. This arrangement ensures, at least dimensionally, the installation compatibility of the terminal body 20 with the dielectric housing 10.

As an example, the pin segment 21, the transition segment 23 and the termination segment 22 are formed by bending a cylindrical terminal having a cross-section with a uniform diameter. Thus, the terminal body 20 can be simply pre-processed by existing processes such as sheet metal processing, thereby simplifying manufacturing. The terminal body 20 is arranged such that, with the pin segment 21 being inserted in place within the first segment 11, the termination segment 22 is placed into the second segment 12 through the first side 121 in a manner pivotable about the transition segment 23.

Through this arrangement, by utilizing, for example, the straight pin segment 21 of the terminal body 20 being first inserted into place within the first segment 11 of the dielectric housing 10, and then utilizing the termination segment 22 of the terminal body 20, which is angled (e.g., orthogonal) relative to the pin segment 21, pivoting relative to the positioned pin segment 21, the termination end is pivoted into the second segment 12 of the dielectric housing 10 and is held in place relative to each other. Thus, with a simple pre-fabricated structure achievable under existing process conditions, reliable relative fixation and positioning between them can be achieved through a simplified two-step operation (specifically, axial insertion and radial pivoting of the pre-processed, nearly right-angled bent terminal body 20 relative to the pre-formed dielectric housing 10). Based on such a structure and assembly arrangement, the inherent barbs and uncertain bending corners in related press-fit assembly structures can be eliminated, thereby overcoming the resulting adverse effects in terms of force/structure and impedance matching, while still ensuring avoidance of reverse withdrawal movement and axial movement of the terminal body 20 relative to the insertion direction; additionally, the inherent strips in related integral molding structures are eliminated, improving their high-frequency performance. Consequently, the structural strength of the components of the electrical connector assembly 1 is effectively enhanced, deformation and accumulated stress generated during the insertion process are reduced, and assembly accuracy as well as impedance matching and high-frequency performance are improved.

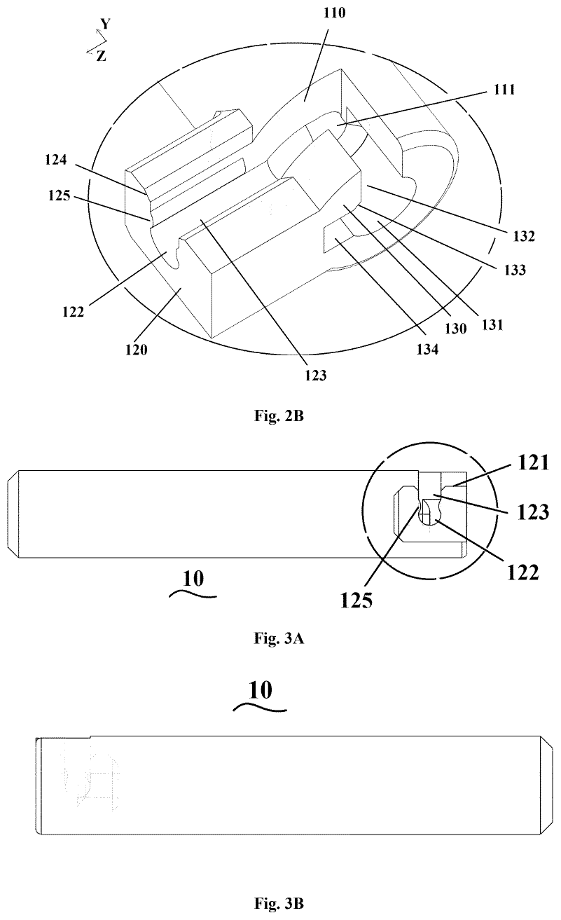

As shown in FIGS. 2A-2B and 3G, for example, the first segment 11 has a first side wall 110 which circumferentially surrounds and defines a first lumen 111 extending in the longitudinal direction Y within the first segment 11, and is adapted to receive the pin segment 21 therein. As further shown in FIGS. 2A-2B and 3G, the second segment 12 has a second side wall 120 which at least partially circumferentially defines a second lumen 122 extending in the vertical direction Z within the second segment 12 and communicates with the first lumen 111, and is adapted to receive the termination segment 22, with the first lumen 111 and the second lumen 122 communicating with each other via the communication cavity. The basic structure of such a dielectric housing 10 can thus be formed by simple molding processes such as injection molding.

As shown in FIGS. 3E-3F, the first segment 11 is in the form of a hollow cylinder. As shown in FIGS. 2A and 3C, the first side wall 110 is a circumferential wall of uniform thickness defining a cylindrical first lumen 111.

As shown in FIG. 3F, the second segment 12 is in the form of a hollow cuboid and is continuously open along its entire length in the vertical direction Z from the first side 121. As shown in FIGS. 2A-2B and 3G, the second side wall 120 is a discontinuous wall of uniform thickness at least partially defining a second lumen 122 that is partially cylindrical.

As shown in FIG. 2A, as an example, the first side 121 of the second segment 12 is defined by continuously removing a portion of the second side wall 120 between a distal end Ed of the second segment 12 away from the first segment 11 and a proximal end Ep of the second segment 12 located at the junction between the first segment 11 and the second segment 12, in the vertical direction Z and parallel to the plane. As shown in FIGS. 2B, the first side 121 is provided with a first open slot 123, which is open along the vertical direction Z, on the second side wall 120.

Through the provision of such a first open slot 123, the feasibility of the radial pivoting step operation for the termination end of the pre-processed, nearly right-angled bent terminal body 20 relative to the second segment 12 of the pre-formed dielectric housing 10 is at least ensured.

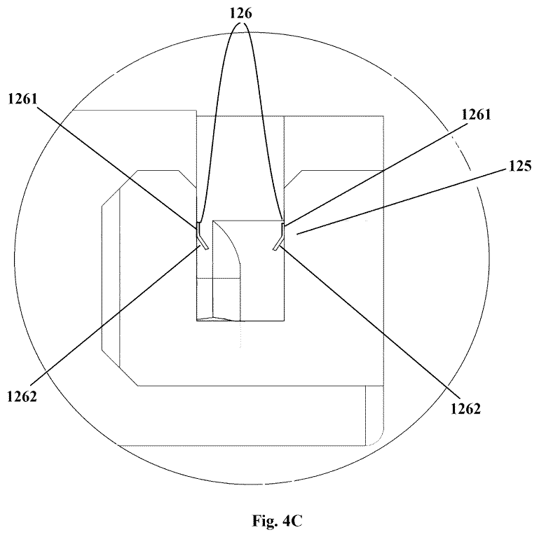

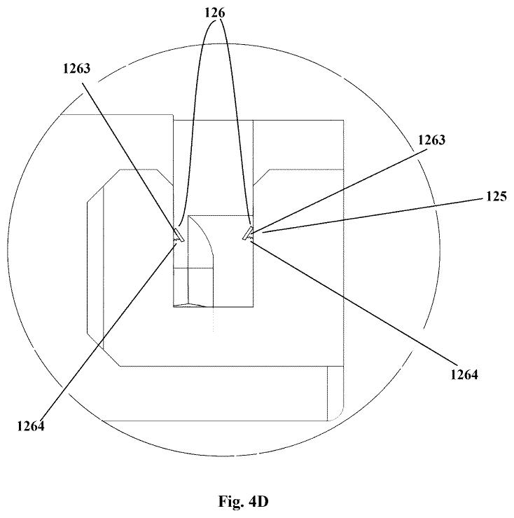

In an exemplary embodiment of the present disclosure, for example, as shown in FIGS. 4A-4B, an open edge 124, as shown in FIGS. 2A-2B, along the vertical direction Z of the second side wall 120 defining the first open slot 123 is beveled or chamfered to taper inwardly toward the interior of the second lumen 122, or alternatively, is rounded to taper inwardly toward the interior of the second lumen 122. This facilitates guiding the termination segment 22 to pivot through the first open slot 123 and then insert into the second lumen 122.

As shown in FIGS. 4A-4B, a narrowed neck portion 125 is formed proximate to the open edge 124 along the vertical direction Z defining the first open slot 123, on the second side wall 120. This narrowed neck portion 125 helps to retain the termination segment 22, which has been inserted from the first side 121 of the second segment 12 through the first open slot 123, within the second lumen 122.

For example, as shown in FIG. 4A, the neck portion 125 has an arcuate arched longitudinal cross-sectional shape. Alternatively, as another example, as shown in FIG. 4B, the neck portion 125 has a trapezoidal arched longitudinal cross-sectional shape. Of course, any other neck portion 125 configuration may alternatively be employed, for example, having a narrowed longitudinal cross-section with an inclined slope on only one side, as long as it meets the narrowed configuration requirement to facilitate retaining the inserted termination segment 22 within the second lumen 122.

In an exemplary embodiment, the minimum width of the first open slot 123 is greater than or equal to the maximum width of the cross-section of the termination segment 22 (for example, the diameter of the circular cross-section of the terminal body 20 is, e.g., 0.68 mm), and is less than the maximum width of the cross-section of the second lumen 122. Thereby, a plug-in segment of the terminal body 20 can pivot through the first open slot 123 unimpeded and enter the second lumen 122. And the minimum width of the first open slot 123 is less than the maximum width of the cross-section of the second lumen 122 (for example, in the case where the second lumen 122 is at least partially a cylindrical lumen, the maximum width of the cross-section of the second lumen 122 can be equivalently considered as the inner diameter of the second lumen 122, e.g., 0.7 mm diameter), which helps ensure that the plug-in segment does not easily slide out through the first open slot 123 even if it rolls or shifts slightly within the second lumen 122.

Optionally, in another exemplary embodiment, the minimum width of the first open slot 123 is smaller than the maximum width of the cross-section of the termination segment 22 (for example, the diameter of the circular cross-section of the terminal body 20 is, e.g., 0.68 mm) by a threshold width difference of at most 0.02 mm to accommodate the second segment 12 being squeezed through, and is less than the maximum width of the cross-section of the second lumen 122 (for example, in the case where the second lumen 122 is at least partially a cylindrical lumen, the maximum width of the cross-section of the second lumen 122 can be equivalently considered as the inner diameter of the second lumen 122, e.g., 0.7 mm diameter). Thereby, the plug-in segment needs to be slightly squeezed through the first open slot 123 when pivoting to enter the second lumen 122, but once the plug-in segment is inside the second lumen 122, it is retained and cannot slide out freely.

In other embodiments, for example, as shown in FIGS. 4C-4D, the first open slot 123 and the second lumen 122 are communicatively integrated and are formed to have a uniform width, and a transition portion of the second side wall 120 proximate to the open edge 124 along the vertical direction Z defining the first open slot 123 functions as a neck portion 125, with a stop member 126 being formed at the neck portion 125.

In an embodiment, as shown in FIG. 4C, the stop member 126 includes at least one pair (for simplicity, only one pair is shown in the figure; in practice, multiple pairs arranged along the vertical direction Z can also be used) of pre-bent resettable elastic sheets. Each pair of elastic sheets are disposed opposite to each other on an inner wall of the second side wall 120, and each elastic sheet in each pair includes a first sheet portion 1261 and a second sheet portion 1262 that are angled relative to each other. The first sheet portion 1261 being fixedly attached against the inner wall of the second side wall 120, and the second sheet portion 1262 being bent and extended from the first sheet portion 1261 toward the interior of the second lumen 122.

Thereby, during the process of the termination segment 22 being pivoted toward the interior of the second lumen 122, the termination segment 22 first presses inward to spread open each elastic sheet in each pair, causing the second sheet portion 1262 of each elastic sheet to be pressed toward the second side wall 120 of the second segment 12, thereby spreading open each pair of elastic sheets, thus increasing the spacing between the two elastic sheets in each pair to allow the termination segment 22 to pass through. Once the termination segment 22 pivots past this stop member 126, the second sheet portion 1262 of each elastic sheet in each pair elastically resets, causing the spacing between the two elastic sheets in each pair to restore, thereby preventing the termination segment 22 from disengaging in reverse. This facilitates retaining the termination segment 22 within the second lumen 122.

In an embodiment, as shown in FIG. 4D, the stop member 126 includes at least one pair of elastic reset devices, each pair of elastic reset devices is disposed opposite to each other on the inner wall of the second side wall 120, and each elastic reset device in each pair includes a sheet 1263 pivotally fixed at one end thereof to the inner wall of the second side wall 120, and a spring 1264 connected between the other end of the sheet 1263 and the inner wall.

Thereby, during the process of the termination segment 22 being pivoted toward the interior of the second lumen 122, the termination segment 22 first presses inward against each pair of elastic reset devices, causing the sheet 1263 of each elastic reset device to be pressed toward the second side wall 120 of the second segment 12 to compress the spring 1264, thereby increasing the spacing between the respective sheets 1263 of the two elastic reset devices in each pair to allow the termination segment 22 to pass through. Once the termination segment 22 pivots past this stop member 126, the spring 1264 in each elastic reset device of each pair is uncompressed and resets by itself, driving the sheet 1263 to reset, thereby restoring the spacing between the respective sheets 1263 of the two elastic reset devices in each pair, preventing the termination segment 22 from disengaging in reverse. This facilitates retaining the termination segment 22 within the second lumen 122.

As shown in FIGS. 2B and 3G, the dielectric housing 10 is further provided with a discontinuous third side wall 130 extending in the longitudinal direction Y and partially arranged circumferentially, at an intersection of the first segment 11 and the second segment 12. The third side wall 130 at least partially defining a counterbore 131, as shown in FIG. 2B, extending along the longitudinal direction Y and communicating with the first lumen 111. As an example, the third side wall 130 is formed by extending from the first side wall 110 along the longitudinal direction Y, and as described in detail below, has multiple portions removed to form hollowed portions such as a second open slot 132 and a groove 134.

As shown in FIG. 2B, the counterbore 131 is arranged coaxially with the first lumen 111, and is configured to guide insertion of the pin segment 21 into the first lumen 111 through its larger inner diameter compared to the first lumen 111. The provision of the counterbore 131 facilitates guiding the correct translational insertion of the pin segment 21 along the longitudinal direction Y, i.e., the axial direction of the first lumen 111, into the first lumen 111.

As shown in FIG. 2B, the third side wall 130 is provided with a second open slot 132 that is continuously open along the longitudinal direction Y to the intersection of the first side wall 110 and the third side wall 130 so as to at least partially expose the counterbore 131, and the second open slot 132 is adapted to accommodate longitudinal Y movement of the termination segment 22 following an insertion action of the pin segment 21 into the first lumen 111 until the termination segment 22 is aligned with the first open slot 123 in the vertical direction Z.

Through the provision of this second open slot 132, the feasibility of the two-step operation of axial insertion of the termination segment 22 of the pre-processed, nearly right-angled bent terminal body 20 following the insertion action of the pin segment 21 relative to the pre-formed dielectric housing 10, and subsequent radial pivoting after the termination segment 22 is stopped by the first side wall 110 of the first segment 11 is at least ensured.

As an example, the minimum width of the second open slot 132 is greater than the maximum width of the cross-section of the termination segment 22, and preferably is, for example, less than the maximum width of the cross-section of the counterbore 131. Through this arrangement, the installation compatibility of the terminal body 20 passing through the second open slot 132 is at least ensured dimensionally.

As another example, the minimum width of the second open slot 132 is less than or equal to the maximum width of the cross-section of the first lumen 111 to help ensure that the terminal body 20, particularly the pin segment 21, does not easily slide out through the second open slot 132 even if it rolls or shifts slightly within the first lumen 111.

As an exemplary embodiment, for example, in a condition that the longitudinal Y movement of the termination segment 22 through the second open slot 132 following the insertion action of the pin segment 21 into the first lumen 111 achieves alignment of the termination segment 22 with the first open slot 123 in the vertical direction Z, the termination segment 22 is triggered to pivot around the transition segment 23 from the first side 121 through the first open slot 123 into the second segment 12. Thereby, through the coordinated arrangement of the first open slot 123 and the second open slot 132, the feasibility of the two-step operation of axial insertion of the termination segment 22 of the pre-processed, nearly right-angled bent terminal body 20 following the insertion action of the pin segment 21 relative to the pre-formed dielectric housing 10, and subsequent radial pivoting after the termination segment 22 is stopped by the first side wall 110 of the first segment 11 is facilitated.

Referring back to FIG. 2B, for example, a portion of the third side wall 130 facing the second side wall 120 is recessed inwards to define a groove 134 radially communicating with the counterbore 131. The provision of the groove 134 is primarily intended to facilitate demolding during injection molding manufacture of the dielectric housing 10.

In a further embodiment, the transition edge 133, as shown in FIG. 2B, of the third side wall 130 at a junction with the counterbore 131 between the second open slot 132 and the groove 134 is rounded, or beveled, or chamfered to taper inwardly toward the interior of the groove 134. This facilitates guiding the termination segment 22 to pivotally transfer from the second open slot 132 to the first open slot 123, awaiting subsequent pivotal insertion into the second lumen 122.

As shown in FIG. 2B, the groove 134 extends along the longitudinal direction Y. The minimum width of the groove 134 is greater than the maximum width of the cross-section of the termination segment 22, and is less than or equal to the maximum width of the cross-section of the first lumen 111. Through this arrangement, the provision of the additional groove 134 allows enough space for the rotation of the curved transition segment 23 located between the pin segment 21 and the termination segment 22 during the transfer of the termination segment 22 from the second open slot 132 to the first open slot 123.

As shown in FIG. 1B, for example, the electrical connector assembly 1 further includes a first seal 30. The first seal 30 is a hollow sealing gasket and is arranged to be coaxially sleeved on the portion of the pin segment 21 protruding from the first lumen 111 and to abut against a surface of the end of the first segment 11 away from the second segment 12. Such a first seal 30 facilitates sealing the electrical connector assembly 1 within external additional seals and housings.

Based on the above-described arrangement of the bent-type electrical connector assembly 1, the following superior technical effects over existing technical solutions in the field can be achieved: by utilizing the straight pin segment 21 of the terminal body 20 being first inserted into place within the first segment 11 of the dielectric housing 10, and then utilizing the termination segment 22 of the terminal body 20, which is angled (e.g., orthogonal) relative to the pin segment 21, pivoting relative to the positioned pin segment 21, the termination end is pivoted into the second segment 12 of the dielectric housing 10 and is held in place relative to each other. Thus, with a simple pre-fabricated structure achievable under existing process conditions, reliable relative fixation and positioning between them can be achieved through a simplified two-step operation (specifically, axial insertion and radial pivoting of the pre-processed, nearly right-angled bent terminal body 20 relative to the pre-formed dielectric housing 10). Based on such a structure and assembly arrangement, the inherent barbs and uncertain bending corners in related press-fit assembly structures can be eliminated, thereby overcoming the resulting adverse effects in terms of force/structure and impedance matching, while still ensuring avoidance of reverse withdrawal movement and axial movement of the terminal body 20 relative to the insertion direction; additionally, the inherent strips in related integral molding structures are eliminated, improving their high-frequency performance. Consequently, the structural strength of the components of the electrical connector assembly 1 is effectively enhanced, deformation and accumulated stress generated during the insertion process are reduced, and assembly accuracy as well as impedance matching and high-frequency performance are improved.

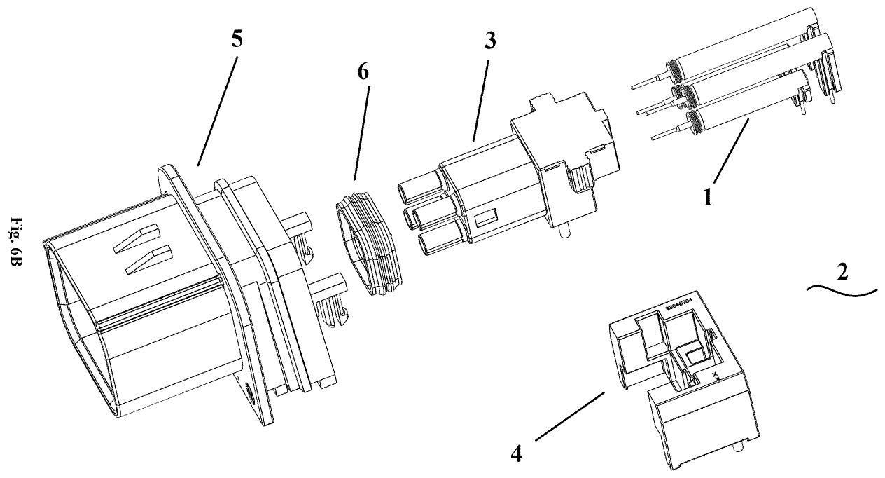

An exemplary embodiment of an electrical connector 2 will now be described with reference to FIGS. 6A-6B. As shown in FIG. 6B, the electrical connector 2 includes a plurality of the electrical connector assemblies 1 as described above, arranged parallel to each other and in an array along the longitudinal direction Y, a shielding member 3 configured to accommodate the plurality of electrical connector assemblies 1 along the longitudinal direction Y, a termination housing 4 configured to at least partially receive the shielding member 3 in the vertical direction Z, and a socket housing 5 configured to at least partially receive the termination housing 4 and the shielding member 3 along the longitudinal direction Y. The electrical connector 2 may also include an external sealing member 6, as shown in FIG. 6B, sleeved on an outer surface of the shielding member 3 and sealed between the outer surface of the shielding member 3 and the inner surface of the socket housing 5.

Furthermore, considering that the electrical connector 2 includes the aforementioned bent-type electrical connector assembly 1, the electrical connector 2 also possesses the advantages of the aforementioned electrical connector assembly 1, which will not be reiterated.

In yet another aspect of the present disclosure, according to a general technical concept of the present disclosure, a method for forming a bent-type electrical connector assembly 1 is also provided.

The method includes: integrally molding a dielectric housing 10, the dielectric housing 10 including the hollow first segment 11 extending in a longitudinal direction Y, and the hollow second segment 12 extending in a vertical direction Z angled (e.g., orthogonal) relative to the longitudinal direction Y, the first segment 11 being integrally molded to be coupled and internally communicating with each other; and forming the nearly right-angled bent terminal body 20 by bending a straight conductive terminal, the terminal body 20 including the straight pin segment 21 adapted to be inserted into the first segment 11 in the longitudinal direction Y, and the straight termination segment 22 angularly coupled (e.g., orthogonally) to the pin segment 21 and adapted to be inserted into the second segment 12 in the vertical direction Z. For example, the second segment 12 is continuously exposed in the vertical direction Z on a first side 121 parallel to a plane defined collectively by both the longitudinal direction Y and the vertical direction Z.

The method further includes, for example: inserting the pin segment 21 into the first segment 11 in the longitudinal direction Y; and in response to the pin segment 21 being inserted in place into the first segment 11 in the longitudinal direction Y and the longitudinal Y movement of the termination segment 22 following the insertion action of the pin segment 21 into the first lumen 111 being stopped by the first segment 11, triggering the termination segment 22 to pivot relative to the pin segment 21 until the termination segment 22 is received and retained in the second segment 12.

In the step of integrally molding the dielectric housing 10, the first segment 11 is formed with the first side wall 110 which circumferentially surrounds and defines a first lumen 111 extending in the longitudinal direction Y within the first segment 11 and is adapted to receive the pin segment 21 therein, and the second segment 12 is formed with the second side wall 120 which at least partially circumferentially defines the second lumen 122 extending in the vertical direction Z within the second segment 12 and communicates with the first lumen 111 and is adapted to receive the termination segment 22, with the first lumen 111 and the second lumen 122 communicating with each other via the communication cavity.

The integrally molding the dielectric housing 10 further includes: continuously removing a portion of the second side wall 120 between the distal end Ed of the second segment 12 away from the first segment 11 and the proximal end Ep of the second segment 12 located at the junction between the first segment 11 and the second segment 12, in the vertical direction Z and parallel to the plane, to define the first side 121. The first side 121 on the second side wall 120 is formed with the first open slot 123 which is open along the vertical direction Z.

In the step of integrally molding the dielectric housing 10, the dielectric housing 10 is further formed with the discontinuous third side wall 130 extending in the longitudinal direction Y and partially arranged circumferentially, at an intersection of the first segment 11 and the second segment 12. The third side wall 130 at least partially defines the counterbore 131 extending along the longitudinal direction Y and communicating with the first lumen 111.

In the step of integrally molding the dielectric housing 10, the third side wall 130 is further formed with the second open slot 132 that is continuously open along the longitudinal direction Y to the intersection of the first side wall 110 and the third side wall 130 so as to at least partially expose the counterbore 131.

In the step of triggering the termination segment 22 to pivot relative to the pin segment 21 until the termination segment 22 is received and retained in the second segment 12, in response to the longitudinal Y movement of the termination segment 22 through the second open slot 132 following the insertion action of the pin segment 21 into the first lumen 111, achieving a condition where the termination segment 22 is aligned with the first open slot 123 in the vertical direction Z, the termination segment 22 is triggered to pivot around the transition segment 23 from the first side 121 through the first open slot 123 into the second segment 12.

The transition portion of the second side wall 120 proximate to the open edge 124 along the vertical direction Z defining the first open slot 123 functions as the neck portion 125. The neck portion 125 is narrowed or formed with a stop member 126, and the termination segment 22 is retained in the second segment 12 by the neck portion 125.

Furthermore, the method for forming the bent-type electrical connector assembly 1 substantially covers a two-step scheme such as the second segment 12 being continuously exposed in the vertical direction Z on the first side 121 parallel to the plane defined collectively by both the longitudinal direction Y and the vertical direction Z; and inserting the pin segment 21 into the first segment 11 in the longitudinal direction Y and triggering the termination segment 22 to pivot relative to the pin segment 21 into the second segment 12 in response to the pin segment 21 being inserted in place into the first segment 11 in the longitudinal direction Y, which is similar to the relevant content of the bent-type electrical connector assembly 1 and the aforementioned electrical connector 2 of the foregoing aspects of the present disclosure. The method also possesses the advantages of the aforementioned bent-type electrical connector assembly 1 and the aforementioned electrical connector 2, which will not be repeated here any more.

The above descriptions of the respective solutions of the bent-type electrical connector assembly 1, the electrical connector 2, and the method for forming the bent-type electrical connector assembly 1 in the foregoing embodiments of the present disclosure are intended to be illustrative, rather than restrictive. Although the present disclosure has been described with reference to the accompanying drawings, the embodiments as disclosed in the drawings are intended to exemplify the preferred embodiments of the present disclosure and should not be construed as a limitation thereof.

Therefore, those skilled in the art will understand that the embodiments described above are exemplary, and those skilled in the art can make improvements. Structures described in various embodiments can be modified and freely combined without conflict in structure or principle. These changes should fall within the protection scope of the present disclosure.

The breadth and scope of the present disclosure should not be limited by any of the above-described exemplary embodiments, but should be defined only in accordance with the following claims and their equivalents.

It should be noticed that the wording “comprising” does not exclude other components or steps, and the wording “a/an” or “one” does not exclude multiple or more than one. Furthermore, any reference numeral(s) in the claims should not be construed to be limitation of the scope of the present disclosure.

1. A bent-type electrical connector assembly, comprising:
a dielectric housing including a hollow first segment extending in a longitudinal direction, and a hollow second segment extending in a vertical direction angled relative to the longitudinal direction, the second segment is coupled to and internally communicates with the first segment; and
a conductive terminal body including a straight pin segment inserted into the first segment in the longitudinal direction, and a straight termination segment angularly coupled to the pin segment and inserted into the second segment in the vertical direction, the second segment is continuously exposed in the vertical direction on a first side parallel to a plane defined by both the longitudinal direction and the vertical direction, when the pin segment is inserted within the first segment, the termination segment is received and retained within the second segment such that the termination segment is pivotable relative to the pin segment.

2. The electrical connector assembly of to claim 1, wherein the terminal body includes a curved transition segment, the pin segment and the termination segment are coupled to each other via the transition segment, the transition segment is accommodated within a communication cavity defined internally at a junction between the first segment and the second segment.

3. The electrical connector assembly of claim 2, wherein the pin segment, the transition segment, and the termination segment are formed by bending a cylindrical terminal having a cross-section with a uniform diameter.

4. The electrical connector assembly of claim 2, wherein, when the pin segment is inserted in place within the first segment, the termination segment is placed into the second segment through the first side such that the termination segment is pivotable about the transition segment.

5. The electrical connector assembly of claim 4, wherein the first segment has a first side wall, the first side wall circumferentially surrounds and defines a first lumen extending in the longitudinal direction within the first segment, the first lumen receives the pin segment therein, the second segment has a second side wall, the second side wall at least partially circumferentially defines a second lumen extending in the vertical direction within the second segment, the second lumen communicates with the first lumen and receives the termination segment, the first lumen and the second lumen communicate with each other via the communication cavity.

6. The electrical connector assembly of claim 5, wherein the first segment is in a form of a hollow cylinder, and the first side wall is a circumferential wall of uniform thickness defining the first lumen, the first lumen has a cylindrical shape.

7. The electrical connector assembly of claim 5, wherein the second segment is in a form of a hollow cuboid, the second segment is continuously open along its entire length in the vertical direction from the first side, the second side wall is a discontinuous wall of uniform thickness at least partially defining the first lumen that is partially cylindrical.

8. The electrical connector assembly of claim 5, wherein the first side of the second segment is defined by continuously removing a portion of the second side wall, between a distal end of the second segment away from the first segment, and a proximal end of the second segment, located at the junction between the first segment and the second segment, in the vertical direction and parallel to the plane, the first side is provided with a first open slot, which is open along the vertical direction on the second side wall.

9. The electrical connector assembly of claim 8, wherein an open edge along the vertical direction of the second side wall defining the first open slot is rounded, beveled, or chamfered to taper inwardly.

10. The electrical connector assembly of claim 9, wherein a narrowed neck portion is formed proximate to the open edge.

11. The electrical connector assembly of claim 8, wherein the first open slot and the second lumen are communicatively integrated and are formed to have a uniform width, a transition portion of the second side wall proximate to the open edge functions as a neck portion, with a stop member formed at the neck portion.

12. The electrical connector assembly of claim 11, wherein the stop member includes at least one pair of pre-bent resettable elastic sheets, each pair of elastic sheets is disposed opposite to each other on an inner wall of the second side wall, each elastic sheet in each pair of elastic sheets has a first sheet portion and a second sheet portion that are angled relative to each other, the first sheet portion is fixedly attached against the inner wall of the second side wall, and the second sheet portion is bent and extends from the first sheet portion toward an interior of the second lumen.

13. The electrical connector assembly of claim 11, wherein the stop member has at least one pair of elastic reset devices, each pair of elastic reset devices is disposed opposite to each other on an inner wall of the second side wall, each elastic reset device in each pair comprises a sheet pivotally fixed at one end thereof to the inner wall of the second side wall and a spring connected between another end of the sheet and the inner wall.

14. The electrical connector assembly of claim 8, wherein the dielectric housing has a discontinuous third side wall extending in the longitudinal direction, the third side wall is partially arranged circumferentially at an intersection of the first segment and the second segment, the third side wall at least partially defines a counterbore extending along the longitudinal direction and communicating with the first lumen.

15. The electrical connector assembly of claim 14, wherein the counterbore is arranged coaxially with the first lumen, the counterbore guides insertion of the pin segment into the first lumen through a larger inner diameter of the counterbore as compared to a diameter of the first lumen.

16. The electrical connector assembly of claim 14, wherein the third side wall has a second open slot, the second open slot is continuously open along the longitudinal direction to the intersection of the first side wall and the third side wall so as to at least partially expose the counterbore, the second open slot accommodates longitudinal movement of the termination segment following an insertion action of the pin segment into the first lumen until the termination segment is aligned with the first open slot in the vertical direction.

17. The electrical connector assembly of claim 16, wherein, in a condition where a longitudinal movement of the termination segment through the second open slot, following the insertion action of the pin segment into the first lumen, achieves alignment of the termination segment with the first open slot in the vertical direction, the termination segment is triggered to pivot around the transition segment from the first side through the first open slot into the second segment.

18. The electrical connector assembly of claim 14, wherein a portion of the third side wall facing the second side wall is recessed inwards to define a groove radially communicating with the counterbore.

19. The electrical connector assembly of claim 18, wherein a transition edge of the third side wall, at a junction with the counterbore between a second open slot and the groove, is rounded, beveled, or chamfered to taper inwardly toward an interior of the groove.

20. The electrical connector assembly of claim 1, further comprising a first seal, the first seal is a hollow sealing gasket coaxially sleeved on a portion of the pin segment protruding from a first lumen, the first seal abuts against a surface of an end of the first segment away from the second segment.

21. An electrical connector, comprising:
a plurality of electrical connector assemblies each including a dielectric housing and a conductive terminal body, the dielectric housing includes a hollow first segment extending in a longitudinal direction, and a hollow second segment extending in a vertical direction angled relative to the longitudinal direction, the second segment is coupled to and internally communicates with the first segment, the conductive terminal body includes a straight pin segment inserted into the first segment in the longitudinal direction, and a straight termination segment angularly coupled to the pin segment and inserted into the second segment in the vertical direction, the second segment is continuously exposed in the vertical direction on a first side parallel to a plane defined by both the longitudinal direction and the vertical direction, when the pin segment is inserted within the first segment, the termination segment is received and retained within the second segment such that the termination segment is pivotable relative to the pin segment, the plurality of electrical connector assemblies are arranged parallel to each other and in an array along the longitudinal direction;
a shielding member accommodating the plurality of electrical connector assemblies along the longitudinal direction;
a termination housing at least partially receiving the shielding member in the vertical direction; and
a socket housing at least partially receiving the termination housing and the shielding member along the longitudinal direction.

22. The electrical connector of claim 21, further comprising an external sealing member sleeved on an outer surface of the shielding member, the external sealing member is sealed between the outer surface of the shielding member and an inner surface of the socket housing.
